(19) United States
(12) Patent Application Publication
(10) Pub. No.: US 2007/0147725 A1
(43) Pub. Date: Jun. 28, 2007

(54) Coupled-waveguide electro-optic switch based on polarisation conversion

(76) Inventors: Paolo Crespi, Milano (IT); Luciano Socci, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/554,933

(22) PCT Filed: Apr. 30, 2003
(86) PCT No.: PCT/IT03/00269

§ 371 Date: Dec. 1, 2006

(51) Int. Cl. G02F 1/295

(52) U.S. Cl. 385/9; 385/8

(57) ABSTRACT

An opto-electronic device comprising a directional coupler provided with a first waveguide to receive incoming electromagnetic radiation, said first guide comprising a guiding region of electro-optic material. Moreover, the directional coupler comprises a second waveguide into which can be coupled at least a first portion of said incoming radiation and provided with a port for radiation being output. The opto-electronic device is equipped with a structure for generating a controlling electric field at least inside said first guide of the directional coupler and such as to cause in said electro-optic material polarization conversion of at least part of said incoming radiation. By means of this polarization conversion it is possible to control the power of the radiation being output from the second waveguide, producing a modulator, a changeover switch, an attenuator or an open-or-closed switch.

The invention relates to opto-electronic devices such as for example optical switches and modulators. In particular, the invention is concerned with devices in which an electro-optic effect is generated.

In general, an optical switch is a device having at least one input port into which electromagnetic radiation may be introduced and at least two output ports between which this radiation may be switched. The switch is provided with control equipment to trigger the switching of the radiation between the two ports.

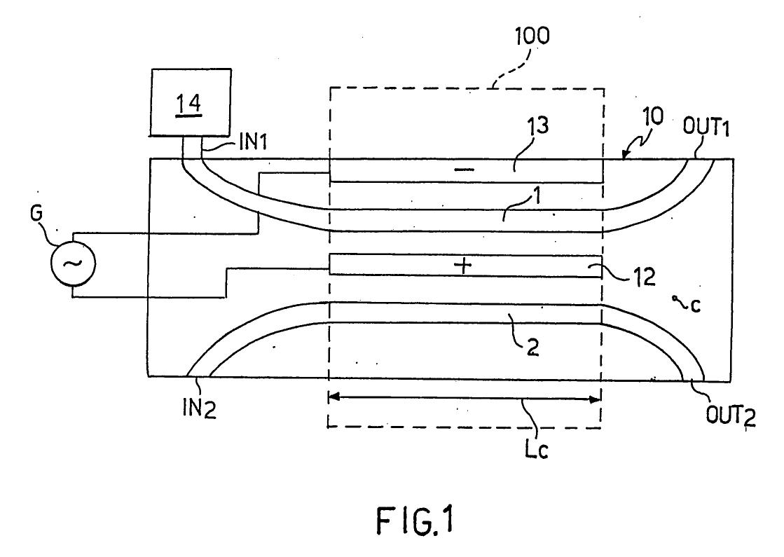

U.S. Pat. No. 4,012,113, referring to the known technology, describes an optical switch (see FIG. 1 in that document) constituted by a directional coupler including two waveguides produced by means of a lithium niobate substrate on which two titanium guides are formed. The waveguides exhibit parallel portions to allow the coupling of an evanescent mode from one guide to the other. The light which is propagated in one of the two optical guides can be transferred to the second guide after a suitable coupling distance. Moreover, the device is provided with two electrodes to which a triggering voltage is applied. The triggering voltage generates an electric field which, by an electro-optic effect, induces a phase difference between the propagation constants of the two guides such as to cancel the directional coupling existing between the guides. Cancelling the directional coupling causes switching to take place between a crossover state and a straight-through or bar state of the optical switch. In this patent it is specified that the optical axis, axis c, of the lithium niobate is parallel to the main components of the electric field generated by the electrodes.

U.S. Pat. No. 4,157,860 describes a modulator/switch produced from lithium niobate and by means of a directional coupler provided with electrodes to which a triggering signal can be applied. According to this patent, for applications such as modulators and switches the point of primary interest is the change of the wave numbers corresponding to changes in the refractive indices n_{TM} and n_{TE}. A vertical electric field having one component along the optical axis of the crystal E_{z} and one component along the y axis of the crystal E_{y} is applied to the waveguide of the directional coupler used. The component E_{z} causes an increase in the dimensions of the ellipsoid of the indices while the component E_{y} causes rotation of that ellipsoid. These two effects cause a change in the refractive index n_{TM} relating to the TM polarization. The rotation of the ellipsoid of the indices due to the component E_{y} cancels an unwanted change in the refractive index n_{TE} relating to the TE polarization. By a suitable choice of the ratio between the component E_{y} and the component E_{z} it is possible to act upon the TM modes without affecting the TE modes. In this document, it is considered that the modulator/switch proposed is independent of polarization.

Moreover, there are known polarization converter devices which starting from incoming electromagnetic radiation having a first type of polarization, produce at the output an electromagnetic radiation having a different type of polarization.

In this connection, U.S. Pat. No. 4,384,760 describes a polarization transformer constituted by a lithium niobate substrate in which an optical path is made. Along this optical path are produced a first phase shifter to vary the relative phase between orthogonal polarization components of incident radiation, a mode converter to vary the relative amplitude of the polarization components and a second phase shifter to vary the relative phase of the polarization components being output from the mode converter. The mode converter comprises a set of electrodes which, if fed with a suitable voltage, cause conversion of a TE (Transverse Electrical) mode into a TM (Transverse Magnetic) mode and vice versa, causing conversion of a polarization component directed along the TE direction into that directed along the TM direction. This conversion is based on an electro-optic effect which involves an off-diagonal coefficient (r₅₁) of the electro-optic tensor of the lithium niobate.

The applicant has noted that it is possible to produce opto-electronic devices which can be used, for example, as switches or modulators, by combining with a directional coupler an electro-optic effect suitable for causing polarization conversion inside at least one of the waveguides of the directional coupler. In particular, the directional coupler used in the opto-electronic device of the invention includes at least one waveguide having a section produced with electro-optic material.

Moreover, the applicant has observed that an opto-electronic device of this type enables radiation entering one of the guides of the coupler to be switched/modulated by applying control voltages having values which are-not prohibitive but suitable for using the device in practical applications, such as those relating to optical telecommunications systems.

It is pointed out that, typically, polarization conversion is affected significantly by birefringence (that is, by the difference between the refractive indices relating to two orthogonal modes of polarization) of the guide in which the conversion occurs.

In this connection, the applicant has found that the invention device can be produced so as not to be critically dependent on the birefringence of the waveguide in which the polarization conversion is produced and therefore exhibiting a satisfactory manufacturing tolerance, in particular as regards the dimensions of the waveguide and the refractive indices of the materials used.

The subject of the invention is an opto-electronic device as defined by the appended claim 1. Particular embodiments of the invention device are defined by claims 2 to 30.

The subject of the invention is also a method of controlling the power of electromagnetic radiation as defined by claim 31. Preferred embodiments of the method according to the invention are defined by claims 32 to 35.

Other characteristics and advantages of the invention will become clearer from the following detailed description of preferred embodiments which are provided purely by way of non-limiting example with reference to the appended drawings, in which:

FIG. 1 shows a schematic view from above of an embodiment of a device according to the invention;

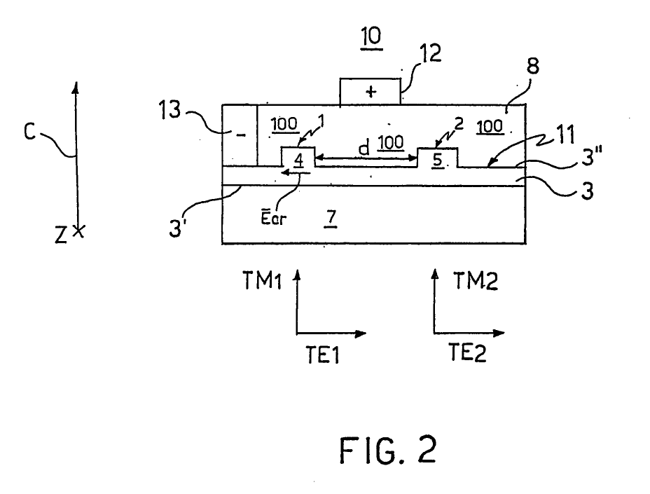

FIG. 2 shows a schematic view of a section through the device in FIG. 1;

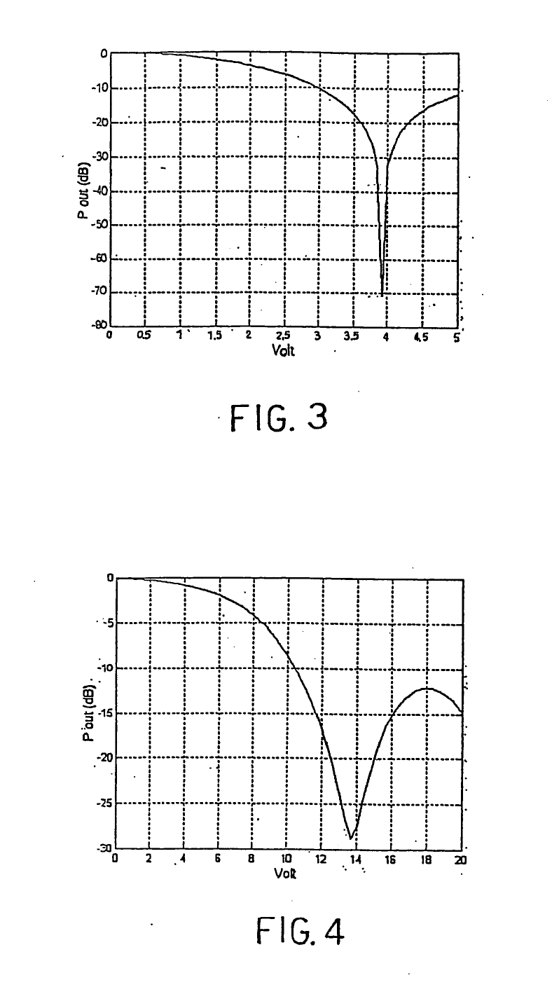

FIGS. 3-5 show graphs representing the output power curves of devices according to the invention;

FIGS. 6-11 show in section further embodiments of devices according to the invention;

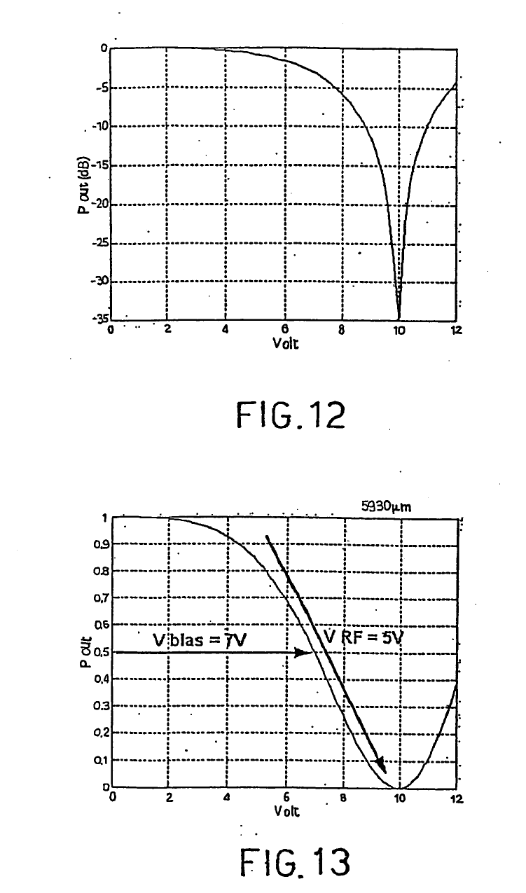

FIG. 12 shows a graph representing the output power curve of a particular embodiment of a device according to the invention,

FIG. 13 shows a graph representing the output power curve of a device produced according to an embodiment of the invention which provides for the use of a bias voltage;

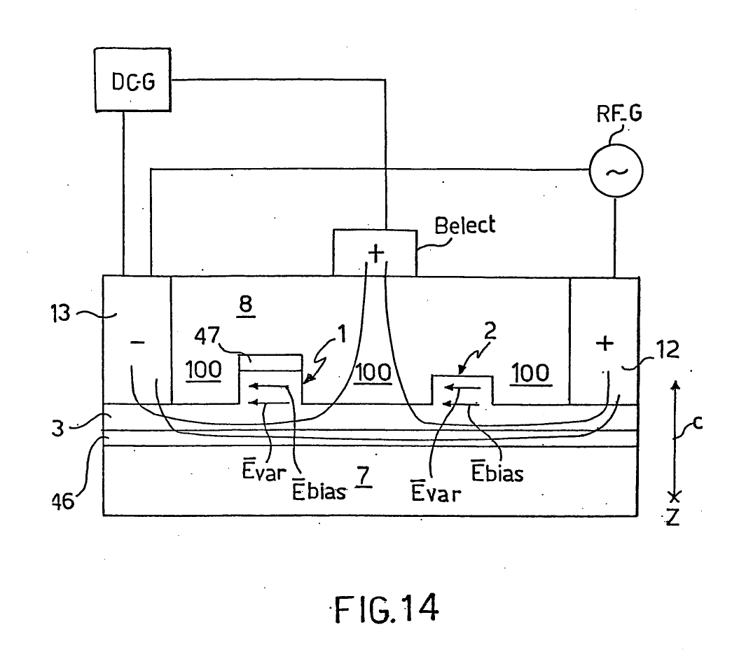

FIG. 14 shows a schematic view in section of an embodiment of the invention device including a bias electrode.

FIG. 1 and FIG. 2 respectively show schematically a view from above and a view in section of an embodiment of an opto-electronic device 10 according to the invention.

This opto-electronic device 10 includes a directional coupler 11 comprising a first waveguide 1 and a second waveguide 2. The first waveguide 1 and the second 2 are arranged side by side for at least a respective coupling section having a length L_{c} suitable to allow the coupling of a least a portion of radiation entering one of the two waveguides to the other waveguide. For example, the two waveguides 1 and 2 are parallel, that is they have parallel axes of propagation, for the coupling section Lc and diverge at the ends. The first waveguide 1 is provided with a first input IN1 and a first output OUT1 and the second waveguide 2 is provided with a second input IN2 and a second output OUT2, for electromagnetic radiation.

Advantageously, the first waveguide 1 and the second waveguide 2 are produced using technologies known in the field of integrated optics. In particular, the first waveguide 1 and/or the second waveguide 2 are rectangular in cross-section and, for example, are guides of the “ridge” type.

Moreover, as shown more clearly in FIG. 2, the first waveguide 1 and second waveguide 2 comprise respectively a first ridge 4 and a second ridge 5, both arranged above a guiding layer 3. The entire guiding layer 3, or at least only the regions of it which are located below the first and the second ridge 4 and 5, exhibit respective refractive indices having values suitable for the propagation of electromagnetic radiation in the waveguides 1 and 2. The opto-electronic device 10 includes a lower cladding 7, on which is arranged a lower surface 3′ of the guiding layer 3, and an upper cladding 8 arranged above an upper surface 3″ of the guiding layer 3. The upper cladding 7 and the lower cladding 8 are produced, for example, using silicon dioxide (SiO2) or by means of another material having a refractive index lower than that of the regions of the guiding layer 3 located below the first and the second ridge 4 and 5 such as, for example, magnesium oxide (MgO) or SOI (Silicon On Insulator). It is also possible for the upper cladding not to be present and for the required index step necessary for propagation in the guide to be provided by the air surrounding the guide.

According to the example described, each of the two waveguides 1 and 2 is a single-mode guide, that is it supports only the fundamental mode of optical radiation having a wavelength comprised within a predetermined interval.

Associated with this fundamental mode is a TE (or transverse electric mode) linear polarization and a TM (or transverse magnetic mode) linear polarization, orthogonal to the preceding one.

In the considerations which follow the expressions “TE1 mode” or “TE1 polarization” (“TM1 mode” or “TM1 polarization”) will be used to indicate the TE (TM) polarization associated with the fundamental mode in the first waveguide 1. Similarly, the expressions “TE2 mode” or “TE2 polarization” (“TM2 mode” or “TM2 polarization”) will be used to indicate the TE (TM) polarization associated with the fundamental mode in the second waveguide 2.

In FIG. 2, respective arrows show the directions of polarization (that is, the directions of vibration of the electric field) for the TE1 and TM1 modes and for the TE2 or TM2 modes.

The directional coupler 11 is such as to couple, that is transfer, at least a portion (more particularly, substantially 100%) of the electromagnetic radiation introduced into the first input IN1 of the first waveguide 1 to the second waveguide 2.

According to the example, the directional coupler 11 is such as to couple the TE1 mode which is propagated in the first waveguide 1 to the second waveguide 2, giving rise to the TE2 mode. The ratio between the power associated with the TE1 mode and that associated with the TE2 mode coupled to the second waveguide 2 is correlated to a coefficient of coupling of the TE modes between these two guides, k_{coup,TE}.

Moreover, the directional coupler 11 is such as to exhibit a coefficient of coupling of the TE modes from the first waveguide 1 to the second waveguide 2 not less than that, k_{coup,TM}, relating to the TM modes:
k_{coup,TE}≦k_{coup,TM} (i)

In other words, the directional coupler 11 is dimensioned so that the ratio between the power transferred to the second waveguide 2 and the power introduced into the first waveguide 1 for the TE modes is not less than the same ratio with respect to the TM modes. According to a particular example, the coupler 11 is such that the coupling for the TM modes is substantially nil:
k_{coup,TM}=0 (ii)

For example, it may be considered that the relation (ii) is satisfied when the percentage ratio between the power with TM polarization coupled to the second waveguide 2 and that with TM polarization present at the first waveguide 1 does not exceed 1% along the coupling section L_{c}.

A person skilled in the art can easily determine the characteristic parameters of the waveguides 1 and 2 (for example length, width, height, distance d between the two integrated waveguides, refractive indices) to obtain the electromagnetic radiation coupling conditions in accordance with what has been described.

The opto-electronic device 10 is provided with a structure for generating a controlling electric field E̅_{cr} which, as will become clearer in what follows, enables the behaviour of the directional coupler 11 to be adjusted.

For example, this generating structure includes a generator G of a control voltage V_{cr}, a positive electrode 12 and a negative electrode 13 (or an earth electrode). According to the example in FIGS. 1 and 2, the positive electrode 12 and negative electrode 13 are integrated with the directional coupler 11 and extend for the coupling section of length L_{c} in parallel with the axes of propagation of the first and second waveguides 1 and 2.

The positive and negative electrodes 12 and 13 together with the side by side sections of the two waveguides 1 and 2 form an active region 100 of the electronic device 10.

As can be seen more clearly from FIG. 2, the positive electrode 12 is arranged above the upper cladding 8 so as to be facing towards a region of the guiding layer 3 comprised between the first waveguide 1 and the second 2. The negative electrode 13 is arranged to the side of the first waveguide 1 and at the opposite end to the end where the second waveguide 2 runs. The positive and negative electrodes 12 and 13 may be made of gold, for example.

The generator G is such as to generate an electrical voltage V_{cr}, and therefore a controlling electric field E̅_{cr}, with a curve as a function of time depending on the particular application chosen for the opto-electronic device 10. In the case where this device 10 is an amplitude modulator, the generator G may operate at radiofrequency, and the control voltage V_{cr}, may have a frequency f_{cr} comprised, for example, between 100 MHz and 100 GHz.

In the case where the device 10 is a switch, the generator G may produce a stationary voltage V_{cr} the value of which is changed when switching takes place.

According to this first embodiment, the two electrodes 12 and 13 generate the controlling electric field E̅_{cr} substantially only inside the guiding layer 3 corresponding to the first waveguide 1, while inside the second waveguide 2 the electric field E̅_{cr} is of negligible magnitude.

Advantageously, at least one of the first waveguide 1 and the second waveguide 2 is produced using an electro-optic material. For example, the electro-optical material is used only for the first waveguide 1.

In particular, the electro-optic material with which the waveguide 1 is produced is such as to allow, under the action of the controlling electric field E̅_{cr}, polarization conversion of the electromagnetic radiation which is propagated inside the first guide. In particular, the conversion which can be obtained is that which couples the TE1 mode (with which the polarization directed along direction TE1 in FIG. 2 is associated) to the TM1 mode (with which the polarization directed along the direction TM1 in FIG. 2 is associated).

The electro-optic material with which the first waveguide 1 is made (in particular, the guiding layer 3 and the first ridge 4) is a crystalline material of anisotropic type, for example.

According to exemplifying embodiments of the invention, this material is also uniaxial, that is it exhibits a single optical axis c (also, termed the crystallographic axis). The optical axis c is that direction of polarization of the electromagnetic radiation which, being propagated in the crystal, is affected by the extraordinary refractive index nₑ.

Preferably, the electro-optic material used to produce the first waveguide 1 is barium titanate BaTiO3. This material has the characteristic that it can advantageously be grown on a silicon substrate, for example, in the form of a thin film. Production on silicon is advantageous because it means that the invention device can be integrated with other opto-electronic devices such as, for example, photodiodes, filters etc., on the same silicon substrate.

For example, the waveguide 1 is obtained by growing barium titanate over a layer of magnesium oxide and in such a way that the barium titanate has the optical axis c oriented along the direction <001>. In other words, the optical axis c is perpendicular to the plane of growth of the barium titanate. FIG. 2 shows the direction of the optical axis c which is orthogonal to the upper surface 3″ of the guiding layer 3.

Besides barium titanate, other electro-optic materials may also be used, having for example a crystallographic axis aligned along the direction <001>. An alternative material to barium titanate may be lithium niobate LiNbO3.

Moreover, the electro-optic material which can be used in the invention is a material having an off-diagonal electro-optic coefficient not equal to zero.

It should be remembered that the electro-optic tensor can be expressed as a 6×3 matrix and the off-diagonal coefficients (for example the coefficients r₄₁, r₄₂, r₄₃, r₅₁) are those external to the sub-matrix above rank 3 or, in other words, belonging to lines 4 to 6 of the tensor.

Particularly preferred are those materials which (with reference to the bulk crystal) have an off-diagonal coefficient greater than about 100 pm/V and, still more preferably, greater than about 500 pm/V evaluated, for example, at ambient temperature, for a wavelength of electromagnetic radiation within the visible spectrum (for example, 633 nm) with a static or low frequency (for example with the frequency of less than 100 kHz) applied electric field.

In producing the device 10 according to the invention, barium titanate is especially advantageous because it has an off-diagonal coefficient r₄₂ with a value equal to about 1300 pm/V.

It is pointed out that the positive electrode 12 and negative electrode 13 are arranged so that the lines of force of the controlling electric field E̅_{cr} are developed inside the first waveguide 1 (in particular inside the corresponding guiding layer 3) so that this electric field is directed perpendicularly to the optical axis c or has at least one component directed perpendicularly to this optical axis. According to the schematic view in FIG. 2, the electric field E̅_{cr} is perpendicular to the optical axis c and to the direction of propagation of the first waveguide 1 (going into the plane of FIG. 2), and therefore parallel to the direction of polarization TE1. As a person skilled in the art knows, the components of the controlling electric field E̅_{cr} perpendicular to the optical axis c make it possible to give rise inside the first waveguide 1 an electro-optic effect which involves rotation of the ellipsoid of the indices of the material in question.

A description will now be given of operation of the opto-electronic device 10 in the case where this functions as an amplitude modulator.

In this case, the opto-electronic device 10 is provided with a laser source 14 connected to the first input IN1 of the first waveguide 1 to generate electromagnetic radiation which is substantially linearly polarised and corresponding to the TE1 mode. For example, the laser source 14 is a semiconductor laser.

Advantageously, this generated radiation has a wavelength of relevance to optical telecommunications such as, for example, a wavelength within the range 800 nm-1700 nm. Preferably, the radiation used has a wavelength comprised within the range 1200 nm-1700 nm or, more preferably, comprised within the range 1400-1700 nm.

When the positive electrode 12 and negative electrode 13 are not fed and therefore do not generate any electric field, the device 10 operates as a directional coupler. The TE1 mode is propagated in the first waveguide 1, giving rise to an evanescent mode which, inside the coupling region of length L_{c}, is transferred at least in part to the second waveguide 2 being propagated in the TE2 mode.

In the case where the device 10 provides 100% coupling, at the second output OUT2 it is possible to collect radiation having substantially the same amplitude and therefore the same power content associated with the TE1 mode.

When the electrical generator G is operated, the positive electrode 12 and the negative electrode 13 are fed generating the controlling electric field E̅_{cr} variable in amplitude with a frequency f_{cr}.

The controlling electric field E_{cr}, directed orthogonally to the optical axis c and to the direction of propagation of the first waveguide 1, produces in the barium titanate of the first waveguide 1 (having the non-zero coefficient r₄₂) polarization conversion of the mode supported by the guide.

In greater detail, a controlling electric field E̅_{cr} causes rotation of the axes of the ellipsoid of the indices relating to the electro-optic material of the first waveguide 1.

As a result of this rotation, the conditions of propagation of the mode supported by the waveguide 1 are changed and this is manifested by a conversion from polarization TE1 to the orthogonal one TM1.

Having configured the directional coupler 11 so as to satisfy relation (i) or in particular relation (ii), the portion of radiation corresponding to the TM1 mode which can be coupled to the second waveguide 2 is limited compared with the coupling between the TE1 and TE2 modes. In fact, the directional coupler 11 is such that the radiation corresponding to the TM1 mode has a “tendency” to coupling to the second waveguide 2 which is substantially nil or, in any case, no greater than the tendency to coupling of the TE1 and TE2 modes.

According to a possible quantitative explanation of the phenomenon underlying the invention, this limitation of the coupling to the second waveguide 2 of the mode resulting from the conversion (in the example, TM1 mode) makes it possible to reduce the portion of radiation coupled as a whole to the second guide until the transfer of energy associated with the normal operation of the directional coupler 11 is substantially cancelled or, in short, until the directional coupler is “destroyed”.

More particularly, it is reasonable to consider that in the device 10, two conflicting effects appear: the effect due to the coupling with the second waveguide 2 and the effect of polarization conversion in the first waveguide 1 associated with the electro-optic effect.

The conflict between these two effects may be such as to inhibit totally or in part the coupling between the first guide 1 and the second 2.

The two effects may be described with sufficient accuracy by considering the matter as follows, on the basis of the known coupled mode theory. According to these considerations, A_{TE1} and A_{TM1} represent the complex amplitudes of the electric fields of the TE1 and TM1 modes, and A_{TE2} and A_{TM2} represent the complex amplitudes of the electric fields of the TE2 and TM2 modes.

In these considerations, the axis z is the axis of propagation of the radiation in the two waveguides considered and the origin z=0 is located in the initial section of the active region 100, as shown in FIG. 1.

Moreover, the initial conditions are: |A_{TE1}|²_{z=0}=1|A_{TM1}|²_{z=0}=0; |A_{TE2}|²_{z=0}=0; |A_{TM2}|²_{z=0}=0 that is, radiation introduced into the first waveguide 1 with TE linear polarization.

The mode equations take this form:

$$\begin{matrix}\frac{ⅆ {A}_{TE 1}}{ⅆ z} = - ⅈ {k}_{eo , 1} {ⅇ}^{ⅈΔ {β}_{eo , 1} z} \cdot {A}_{TM 1} - ⅈ {k}_{coup , TE} {ⅇ}^{{ⅈΔβ}_{coup , TE \cdot } z} \cdot {A}_{TE 2} & ( 1 ) \\ \frac{ⅆ {A}_{TM 1}}{ⅆ z} = - ⅈ {k}_{eo , 1} {ⅇ}^{{ⅈΔβ}_{eo , 1} z} \cdot {A}_{TE 1} & ( 2 ) \\ \frac{ⅆ {A}_{TE 2}}{ⅆ z} = - ⅈ {k}_{coup , TE} {ⅇ}^{{ⅈΔβ}_{coup , TE \cdot } z} \cdot {A}_{TE 1} & ( 3 )\end{matrix}$$

In these equations, the quantities Δβ_{eo,1} and Δβ_{coup,TE} are expressed by the following differences between the propagation constants β associated with the modes of the two waveguides:
Δβ_{eo,1}=β_{TE1}−β_{TM1}=(n_{TE1}−n_{TM1})2π/λ
Δβ_{coup,TE}=β_{TE1}−β_{TE2}=(n_{TE1}−n_{TE2})2π/λ

in which n_{TE1} and n_{TM1} are the effective refractive indices of the TE and TM modes of the first waveguide 1, and n_{TM2} and n_{TE2} are respectively the effective refractive indices of the TE and TM modes of the second waveguide 2. As known to a person skilled in the art, the effective refractive indices take account of the actual structure of the waveguides produced and correlate to the ordinary and extraordinary refractive indices of the unworked or bulk crystal.

The factor k_{eo,1} is the electro-optic coupling coefficient between the TE mode and the TM mode of the first waveguide 1 and, in this case, is proportional to the electro-optic coefficient r₄₂ and to the amplitude E_{cr} of the controlling electric field E̅_{cr} directed orthogonally to the optical axis c and to the direction of propagation of the first waveguide 1 (or proportional to a component of the controlling electric field E̅_{cr} orthogonal to the optical axis c and to the direction of propagation of the first waveguide 1).

The factor k_{coup,TE} is the coefficient of coupling for the TE polarization between the two waveguides 1 and 2 and depends on the geometry of the directional coupler 11 and on the effective refractive indices for the TE mode in the first waveguide 1, n_{TE1}, and in the second waveguide 2, n_{TE2}.

In equation (1), the first term describes the polarization conversion (that is the conversion TE1→TM1) which occurs in the first waveguide 1 because of the controlling electric field E̅_{cr}, while the second term describes the coupling to the second guide 2 (that is the coupling TE1→TE2) due to the configuration of the directional coupler 11.

Equation (2) refers to the TM mode which is generated in the first guide 1 because of the polarization conversion resulting from the electro-optic effect (that is the TM1 mode). Equation (3) refers to the TE mode which is generated in the second guide 2 as a consequence of the coupling between the first guide 1 and the second guide 2 (that is the TE2 model.

It is pointed out that the equations indicated above refer, in accordance with what has been described above with reference to the device 10, to the cases in which there is no electro-optic effect in the second waveguide 2 and there is no coupling from the first guide 1 to the second guide 2 of the TM mode. In other words, equations (1), (2) and (3) refer to a device configured so that a coefficient of electro-optic coupling k_{eo,2} for the second guide 2 is substantially nil and so that a coupling coefficient k_{coup,TM} between the two guides for the TM polarization is substantially nil (k_{eo,2}=0; k_{coup,TM}=0).

It should be noted that, for example, it may be considered that k_{eo,2} is substantially nil when the percentage ratio between the power of the TM radiation converted in polarization and that of the TE radiation present in the second waveguide 2 is no greater than 1%.

It is also possible for the invention device to be configured so that the coupling between the two waveguides for the TM is non-zero k_{coup,TM}≠0.

In this case in equation (2) it is necessary also to consider a term having the following form
−ik_{coup,TM}e^{iΔβ}^{_{coup,TM}}^{·z}·A_{TM2}

which expresses the presence of this coupling for the TM modes. The coupling coefficient k_{coup,TM} depends on the geometrical layout of the first waveguide 1 and of the second 2, and on their effective refractive indices.

The quantity Δβ_{coup,TM} is given by the relation
Δβ_{coup,TM}=β_{TM1}−β_{TM2}=(n_{TM1}−n_{TM2})2π/λ.

According to a first embodiment of the invention, the differences Δβ_{eo,1} and Δβ_{coup,TE} are both substantially nil, that is there is no phase difference between the two modes TE1 and TM1 of the first waveguide 1, and there is no phase difference between the modes TE1 and TE2 which are coupled from the first waveguide 1 to the second 2.

The first condition (Δβ_{eo,1}=0) is achievable by using a first waveguide 1 with substantially nil birefringence, n_{TE1}≈n_{TM1} (for example, the birefringence is no greater than 5,0·10⁻⁵). This is achievable, for example, when the device 10 is manufactured, using known techniques of integrated optics which provide for the production of layers of material with a refractive index different from that of the guiding layer 3 or of the ridge 4 arranged above the ridge 4 and/or below the guiding layer 3.

Alternatively, it is possible to reduce the birefringence of the first waveguide by using finger electrodes of suitable periodicity.

The second condition (Δβ_{coup,TE}=0) can be achieved, for example, by producing a first guide 1 so that it has an effective refractive index n_{TE1} substantially equal to the index n_{TE2} of the second waveguide 2 (for example, the difference between the indices n_{TE1} and n_{TE2} is no greater than 1,0·10⁻⁵). This can be achieved at the manufacturing stage by suitable choice of materials and dimensions of the two waveguides 1 and 2. For example, it is possible to use waveguides 1 and 2 substantially identical in materials and dimensions.

In case of the assumptions cited above, the solutions to equations (1), (2), (3) take the following form:
A_{TE1}=cos(Kz) (4)
A_{TM1}=−i(k_{eo,1}/K)sin(Kz) (5)
A_{TM2}=−i(k_{coup,TE}/K)sin(Kz) (5)

in which:
K=\sqrt{k_{eo,1}²+k_{coup,TE}²}

Preferably, the opto-electronic device 10 is produced so that the effect of polarization conversion inside the first waveguide 1 is greater compared with the coupling effect which is manifested in the directional coupler 11.

In particular, in predetermined operating conditions of the device 10, the electro-optic coupling coefficient k_{eo,1} is greater than the coupling coefficient between the guides k_{coup,TE}:
k_{eo,1}>k_{coup,TE}. (iii)

For example, k_{eo,1} is equal to at least twice k_{coup,TE}. This can be achieved by applying a potential difference V_{cr} variable in time in accordance with the desired modulation and having, for example, a peak-to-peak value such as to generate a controlling electric field E̅_{cr} having a suitably high maximum amplitude.

Expression (6) shows that if k_{eo,1}>>k_{coup,TE} the field A_{TE2} tends to zero, that is, in this situation, by means of the controlling electric field E̅_{cr} the coupling between the two waveguides 1 and 2 is reduced (or is substantially cancelled).

In particular, the electromagnetic radiation (which is propagated with the TE2 mode) present at the second output OUT2 may be reduced or substantially cancelled relative to that measured in the absence of the controlling electric field E̅_{cr}.

The variability in time of the control voltage V_{cr} according to the frequency f_{cr} leads to modulation of the amplitude of the fields of the radiation present at the second output OUT2 and therefore allows modulation of the power of the radiation present at this output.

In particular, by switching between a minimum value and a maximum value the amplitude of the control voltage V_{cr} (with a frequency f_{cr}), on-off modulation of the radiation emitted by the laser source 14 will be possible. In this case, the second output OUT2 is the useful port which makes the modulated radiation available, while the first output OUT1 may be used as a port to monitor the operation of the device 10.

The applicant has carried out a computer simulation considering a device of the type described above (Δβ_{eo,1}=Δβ_{coup,TE}=0) which uses barium titanate as the electro-optic material. According to this simulation, the length of the active region 100 was chosen as equal to 3000 μm.

This first simulation was carried out by considering the following values for the parameters of the device 10: wavelength λ=1.55 μm; coefficient r₄₂=500 pm/V (taking account of the lowering of r₄₂ caused by the production of thin films of barium titanate compared with the bulk crystal value); k_{coup,TE}=5.2 10⁻⁴ μm⁻¹; k_{coup,TM}=0; k_{eo,2}=0; n_{TE1}=n_{TM1}=1.9359.

This simulation demonstrated that by applying a potential difference V_{cr} approximately equal to 3.9 V, it is possible substantially to cancel the electromagnetic power which is output at the second output OUT2.

In these operating conditions, the value k_{eo,1} is equal to 9.2 10⁻⁴ m⁻¹.

FIG. 3 shows the curve of the electromagnetic power Pₒᵤₜ₂ expressed in dB and which can be measured at the second output OUT2 when the control voltage V_{contr} applied to the electrodes 12 and 13 is increased.

As can be seen from the graph in FIG. 3, for values of voltage V_{cr} comprised between 3.8 V and 4 V, an extinction or notch of the power P_{OUT2} of more than 40 dB is obtained.

The simulations also demonstrated that, at least for values of the voltage V_{cr} comprised between 3.8 V and 4 V, the performance of the device 10 as regards extinction of the power Pₒᵤₜ₂ exhibit a satisfactory tolerance with respect to deviations in the actual length of the coupling region 100 relative to the nominal value L_{c} equal to 3000 μm.

In accordance with a second embodiment of the invention, the first waveguide 1 and the second 2 are such as to exhibit a phase mismatch condition between the TE1 and TM1 modes and the TE1 and TE2 modes.

In other words, the difference between the propagation constants for the TE and TM modes in the first waveguide 1 is not equal to zero, Δβ_{eo,1}≠0; and the difference between the propagation constants of the TE mode of the first waveguide 1 and the TE mode of the second waveguide 2 is not equal to zero, Δβ_{coup,TE}≠0.

In this case, to obtain the desired effect of modulation of the power present at the second output OUT2 it is useful to apply a controlling electric field E̅_{cr} with an amplitude greater than that which can be applied in the case described previously. For example, the control voltage V_{cr} applied is greater than the value approximately equal to 10 V and, preferably, is comprised between 10 and 30 V.

According to a qualitative analysis, the phase mismatch condition Δβ_{eo,1}≠0, implies that the electro-optic coupling coefficient of equations (1), (2) and (3) is multiplied by an exponential factor equal to e^{iΔβ}^{_{ro,1}}^{z}. This factor reduces on average the amplitude of the electro-optic coefficient, without completely impeding the action of polarization conversion.

In this case, polarization conversion is best described by an effective electro-optic coupling coefficient k_{eo,1-eff} obtained from an averaging operation carried out on the length of the active region 100 and equal to:
k_{eo,1-eff}=ik_{eo,1}<e^{iΔβ}^{_{eo,1}}^{z}> (7)

Similarly, the condition Δβ_{coup,TE}≠0 implies that for the coupling of the TE mode between the two waveguides 1 and 2, an effective coefficient k_{coup,TE-eff}, also obtained from an averaging operation, can be defined:
k_{coup,TE-eff}=ik_{coup,TE}<e^{iΔβ}^{_{coup,TE}}^{z}> (7′)

Moreover, in this second embodiment, a condition similar to condition (iii) is considered valid, according to which the effective electro-optic coefficient k_{eo,1-eff} is in any case greater than the coefficient k_{coup,TE-eff} of effective coupling between the modes in the first and second waveguide:
k_{eo,1-eff}>k_{coup,TE-eff} (iiii)

The applicant has carried out a simulation of the operation of a device similar to the one described with reference to FIGS. 1 and 2, but produced according to this alternative embodiment, Δβ_{eo,1}≠0⁻, Δβ_{coup,TE}≠0. For this second simulation, the same values were considered as those defined for the first simulation except for the value of the birefringence n_{TE1}−n_{TM1} equal to 1,0·10⁻³, and the value of the difference n_{TE1}−n_{TE1}, equal to 0,51⁻⁴.

FIG. 4 shows the curve for the power P_{OUT2} present at the second output when the amplitude of the voltage V_{contr} is increased. For values of the voltage V_{coutr} comprised between 13.5 V and 14.5 V, a notch greater than 20 dB is obtained. For values approximately equal to 13.8 V, a notch comprised between 25 dB and 30 dB is obtained. Moreover, the simulations have shown that, in this case too, the device shows good tolerance as regards the actual length of the coupling region 100.

According to a third embodiment of the invention, the opto-electronic device 10 is produced in accordance with the assumptions relating to the first or second embodiment of the invention with the difference that relations (iii) or (iiii) are not satisfied.

For example, in this situation, the coupling between the first waveguide 1 and the second 2 is greater than the polarization conversion in the first guide 1, k_{coup,TE}>k_{eo,1} (“strong coupling” condition).

Advantageously, the strong coupling condition enables shorter devices to be produced. Moreover, in this condition the coupling of the radiation from the first waveguide 1 to the second 2 with a nil electric field applied is found to be less affected by manufacturing errors.

In this case, the field A_{TE2} exhibits a periodic behaviour along the axis of propagation z of the sinusoidal type (as can be understood intuitively by observing the solution expressed by relation (6)):
A_{TE2}∝ sin(\sqrt{k_{eo,1}²+k_{coup,TE}²}Z)

On the basis of the relation indicated above, it is possible to determine (as a function of the control voltage V_{cr} and therefore of the controlling electric field E̅_{cr} and of the electro-optic coefficient k_{eo,1}) the distance L_{notch}, evaluated from the origin z=0, of a section of the device 10 corresponding to a minimum of the power associated with the TE2 mode.

The applicant has carried out a simulation of the operation of the device 10 configured in accordance with this third embodiment of the invention.

In this third simulation, the same values for the parameters indicated for the first and the second simulation are considered, except for the value of k_{coup,TE} which was taken as equal to 7.9·10⁻³ μm⁻¹. Moreover, the directional coupler 11 was configured so that in the absence of an external electric field E̅_{cr}, the maximum transfer of power from the first guide 1 to the second 2 occurs for a length of the side by side sections of the two guides 1 and 2 equal to 200 μm (corresponding to the period of the directional coupler 11).

The simulation showed that, for particular values of the control voltage V_{cr}, a substantial cancellation of the power P_{OUT2} being output from the second waveguide 2 occurs (among other possible values) for a length of the active region 100 equal to z′=2600 μm, that is equal to about thirteen times the period of the directional coupler 11.

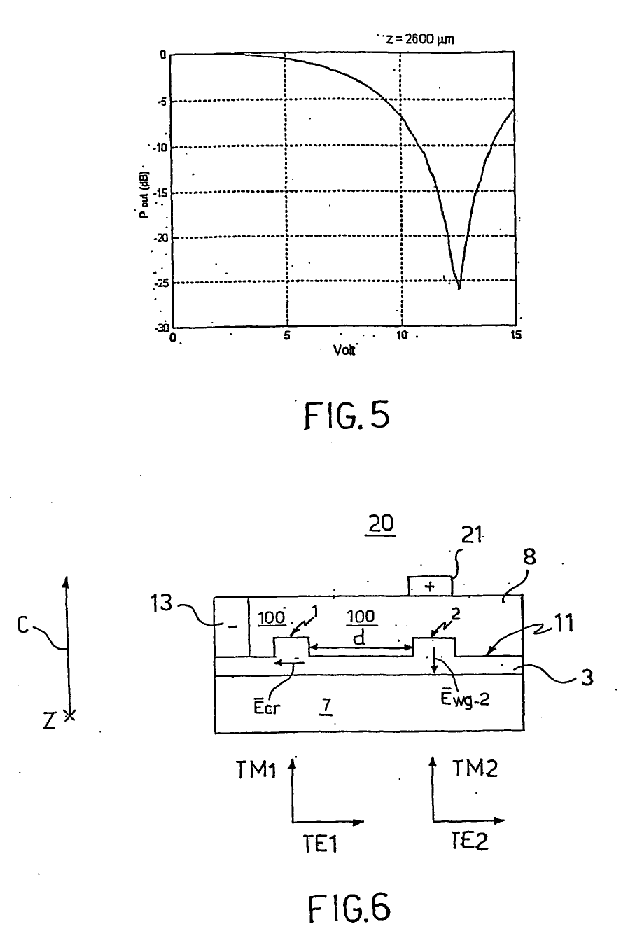

As shown in FIG. 5, at the distance z′ and for values of the control voltage V_{cr} comprised between 12 V and 13 V, a notch of more than 20 dB was obtained, and in particular, at about 12.5 V, a notch of more than 25 dB was obtained; in this operating condition k_{eo,1} is equal to 2.9·10⁻³ μm⁻¹.

These results relating to the third embodiment of the invention showed that the opto-electronic device 10 allows a reduction in output power at the OUT2 port (and therefore the possibility of modulating this) even in the case where the polarization conversion induced in the first guide (TE1→TM1) is not particularly efficient.

In particular, the opto-electronic device 10 may be configured so that the polarization conversion is non-negligible, that is the percentage ratio P_{conv}/Pᵢₙ between the incoming power Pᵢₙ associated with the TE polarization and the power P_{conv} associated with the TM polarization and resulting from conversion (evaluated in a section z where it is maximum) is greater than about 1%.

Preferably, this ratio is greater than 5% and more preferably is greater than 10%. According to particular embodiment, the conversion ratio is greater than 40%. In any case it is not necessary for the polarization conversion from TE to TM to be complete.

It should be noted that it is possible for the controlling electric field E̅_{cr} to exhibit inside the first waveguide 1 components not orthogonal to the optical axis c such as to cause a variation in at least one of the effective refractive indices n_{TE1} and n_{TM1} of the first waveguide 1.

In accordance with the invention, these variations in the effective refractive indices n_{TE1} and n_{TM1} may also contribute to modulation of the behaviour of the directional coupler 11 but in any case, do not perform a fundamental role for this modulation which, instead, is performed by the action of polarization conversion.

Moreover, as a result of simulations it has been noted that the opto-electronic device 10 exhibits a satisfactory tolerance with respect to deviations in the birefringence n_{TE1}−n_{TM1} (and therefore in the difference Δβ_{eo,1}) of the first waveguide 1. In particular, a tolerance to deviations in birefringence of about 40% has been noted.

In this connection, the applicant has observed that the behaviour of the device 10 as regards destruction of the directional coupler remained substantially unchanged both for values of the difference Δβ_{eo,1} of less than 0.001 (the value referred to in FIG. 5) and also for a value equal to 0.0014. In particular, considering Δβ_{eo,1}=0.0014 and for values of the voltage V_{contr} approximately equal to those indicated above (12.5 V-13.5 V) extinction equal to about 15 dB was obtained.

FIG. 6 shows a fourth embodiment of the invention which is produced as an opto-electronic device 20. In FIG. 6 and in the figures following, components identical or similar to those already described are indicated using the same reference numbers.

The device 20 is similar to the device 10 described above but differs from it because, instead of the positive electrode 12 it includes a different positive electrode 21 produced so as to generate together with the negative electrode 13 an electric field E̅_{wg-2} also inside the second waveguide 2. In particular, the positive electrode 21 extends above the second waveguide 2 and is substantially facing towards it.

Moreover, the second waveguide 2 may optionally be produced with an electro-optic material such as, for example, the same material as the first waveguide 1.

This controlling electric field E̅_{wg-2} does not exhibit substantial components orthogonal to the optical axis c of the second waveguide 2 and therefore is not capable of causing significant polarization conversion in this guide.

In particular, the controlling electric field E̅_{cr} is substantially parallel to the optical axis c of the crystal of the second waveguide 2 and therefore, if the second waveguide 2 includes electro-optic material, is capable of causing a phase difference between the modes guided in the second guide but not polarization conversion.

Consequently, the operation of the device 20 is similar to that described with reference to the three possible embodiments of the device 10, according to which k_{eo,2} was zero.

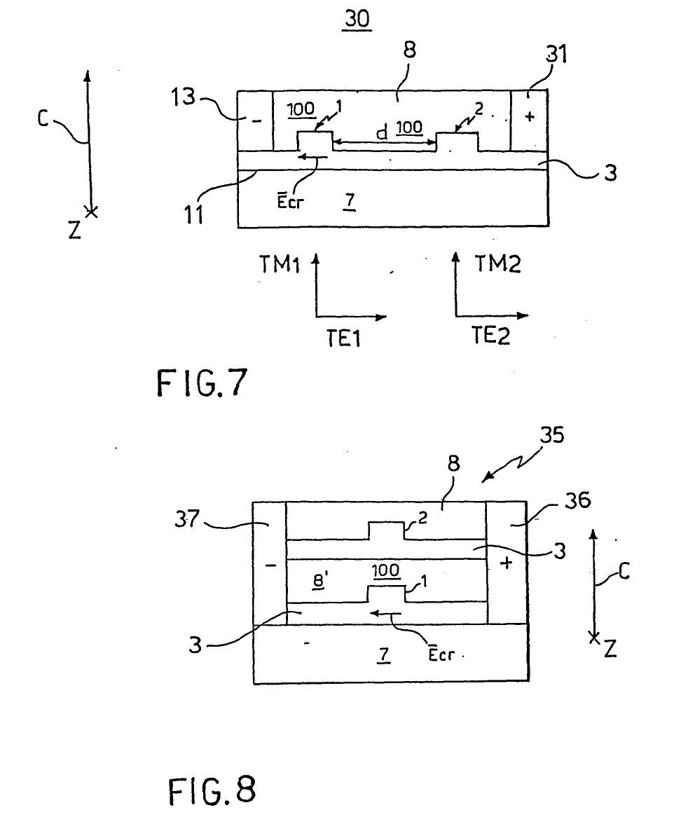

FIG. 7 shows an opto-electronic device 30 produced according to the fifth embodiment of the invention. According to this fifth embodiment, the second waveguide 2 (second ridge 5 and region of the guiding layer 3 below it) is produced with a substantially non-electro-optic material such as, for example, silicon nitride, silicon dioxide or silicon.

Moreover, the device 30 includes a positive electrode 31 arranged to the side of the second waveguide 2 so that both guides 1 and 2 are affected by the controlling electric field E̅_{cr}, directed orthogonally to the optical axis c. However, since the second waveguide 2 does not include electro-optic material, polarization conversion induced by the controlling electric field E̅_{cr} does not occur in it.

For example, the opto-electronic device 30 in FIG. 7 is configured so as to satisfy relation (i) (k_{coup,TE}≦k_{coup,TM}) cited above but with non-zero coupling between the first waveguide 1 and the second waveguide 2 for the TM mode (TM1→TM2): k_{coup,TM}≠0.

Even in the presence of the coupling relating to the TM mode, it is possible to modulate the output power and substantially destroy the directional coupling in a manner similar to that described above.

FIG. 8 shows an opto-electronic device 35 produced according to a sixth embodiment of the invention. According to this sixth embodiment, the second waveguide 2 extends above the first waveguide and is produced on a separating layer 8′ produced, for example, from silicon dioxide or with another material having a refractive index less than that of the guiding layer of the first waveguide 1 and the second 2. The second waveguide 2 is substantially aligned with the first waveguide 1 or, in other words, the first waveguide 1 and the second 2 have respective axes of propagation going into the plane of FIG. 8.

The device 35 includes a negative electrode 37 and a positive electrode 36 arranged on opposite outer sides of the two waveguides so as to generate an electric field E̅_{cr} which is perpendicular to the optical axis c and to the direction of propagation of the guides.

According to this sixth embodiment, the second waveguide 2 is produced with a substantially non-electro-optic material such as, for example, silicon, silicon dioxide or silicon nitride.

In this case too, no polarization conversion occurs inside the second waveguide 2.

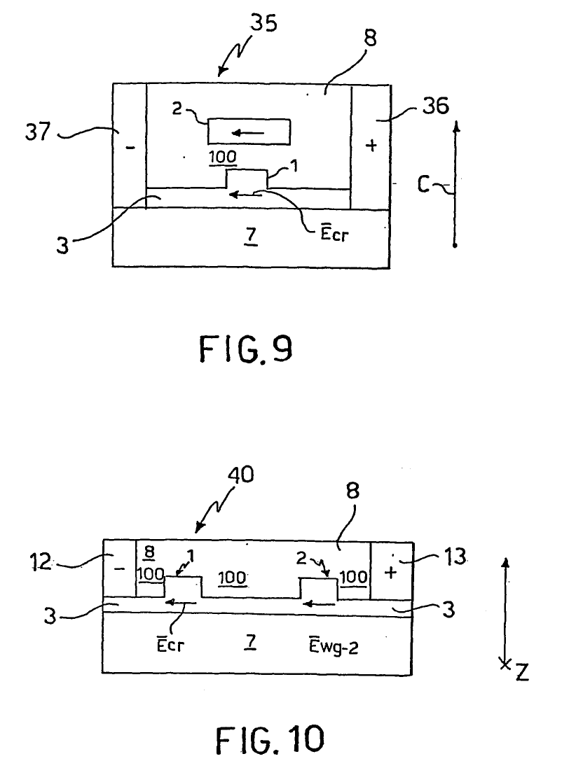

FIG. 9 also shows an alternative embodiment to the one in FIG. 8, comprising a second guide 2′ of the buried type produced from non-electro-optic material and having, for example, a rectangular core.

Similarly to what has been described with reference to the device in FIGS. 1 and 2, the fourth, fifth and sixth embodiments corresponding to the devices 20 (FIG. 6), 30 (FIG. 7) and 35 (FIG. 8) may also be produced so that all the relations previously described with reference to the first, second and third embodiment are satisfied.

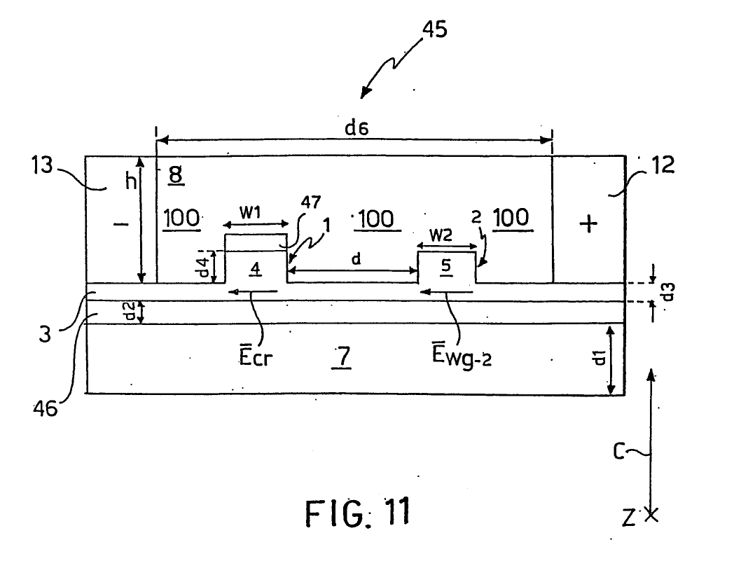

FIG. 10 shows an opto-electronic device 40 corresponding to a seventh embodiment of the invention.

The structure of the device 40 and its operation are similar to those of the device 10, except for differences which are indicated below.

In the device 40, both the waveguides 1 and 2 are produced with electro-optic material. Unlike the description given with reference to the device 10 in FIG. 1, the embodiment in FIG. 10 provides for the negative electrode 13 and positive electrode 12 to be such as to generate an electric field E̅_{wg-2} inside the second waveguide 2 with an orientation such as to cause polarization conversion due to the electro-optic effect in this second guide too. The electrodes 12 and 13 are arranged externally to the two guides 1 and 2 and on opposite sides to them.

Moreover, according to the embodiment in FIG. 10, a coefficient of coupling is considered for the TM mode between the first guide 1 and the second guide 2 not equal to zero, k_{coup,TM}≠0.

In these assumptions, the equations which describe the fields in the two guides take the following form:

$$\begin{matrix}\frac{ⅆ {A}_{TE 1}}{ⅆ z} = - ⅈ {k}_{eo , 1} {ⅇ}^{{ⅈΔβ}_{eo , 1} z} \cdot {A}_{TM 1} - ⅈ {k}_{coup , TE} {ⅇ}^{{ⅈΔβ}_{coup , TE \cdot } z} \cdot {A}_{TE 2} & ( 8 ) \\ \frac{ⅆ {A}_{TM 1}}{ⅆ z} = - ⅈ {k}_{eo , 1} {ⅇ}^{{ⅈΔβ}_{eo , 1} z} \cdot {A}_{TE 1} - ⅈ {k}_{coup , TM} {ⅇ}^{{ⅈΔβ}_{coup , TM \cdot } z} \cdot {A}_{TM 2} & ( 9 ) \\ \frac{ⅆ {A}_{TE 2}}{ⅆ z} = - ⅈ {k}_{eo , 2} {ⅇ}^{{ⅈΔβ}_{eo , 2} z} \cdot {A}_{{TM}_{2}} - ⅈ {k}_{coup , TE} {ⅇ}^{{ⅈΔβ}_{coup , TE \cdot } z} \cdot {A}_{TE 1} & ( 10 ) \\ \frac{ⅆ {A}_{TM 2}}{ⅆ z} = - ⅈ {k}_{eo , 2} {ⅇ}^{{ⅈΔβ}_{eo , 2} z} \cdot {A}_{TE 2} - ⅈ {k}_{coup , TE} {ⅇ}^{{ⅈΔβ}_{coup , TM \cdot } z} \cdot {A}_{TM 1} & ( 11 )\end{matrix}$$

These equations are a generalisation of equations (1), (2) and (3) defined previously. In fact, it is possible to go back to them or to the embodiment describeds previously by cancelling specific parameters which appear in the equations.

Some of the quantities indicated in these equations have already been defined and the remaining quantities are:
Δβ_{eo,1}=β_{TE1}−β_{TM1}=(n_{TE1}−n_{TM1})2π/λ;
Δβ_{eo,2}=β_{TE2}−β_{TM2}=(n_{TE2}−n_{TM2})2π/λ;
Δβ_{coup,TE}=β_{TE1}−β_{TE2}=(n_{TE1}−n_{TE2})2π/λ;
k_{e0,2÷r}₄₂E_{wg-2}

The physical significance of these quantities is clear to a person skilled in the art on the basis of the description above and of the indices which distinguish them.

In general, the more the refractive indices relating to the same mode (for example TE) are equal in the two guides 1 and 2 (that is, n_{TE1} close to n_{TE2}) the greater the coupling of that mode from one guide to the other.

Considering the quantity Δβ_{eo,2} not equal to zero, it is appropriate to define the effective coupling coefficient k_{eo,2-eff}:
k_{eo,2-eff}=ik_{eo,2}<e^{iΔβ}^{_{eo,2}}^{z}>

The applicant has observed that by securing the following condition:
k_{e0,1-eff}>k_{e0,2-eff} (12)

it is possible to obtain destruction of the directional coupler 11 to which there corresponds the switching of the radiation.

The relation (12) expresses the fact that the polarization conversion effect linked to the electro-optic effect inside the first waveguide 1 (that is the guide into which the incoming radiation is introduced) is greater than that which may occur inside the second guide 2. In other words, the invention device is configured so that the ratio between the power of the radiation converted in polarization and that of the radiation introduced (evaluated for a value of z in which the ratio is maximum) is greater for the first waveguide compared with that relating to the second waveguide.

Still according to a qualitative analysis, the polarization conversion in the second guide 2 has an effect which “opposes” destruction of the directional coupler 11 in that it leads to the generation of a TM2 mode (see equations (10) and (11)) and therefore it is appropriate to limit it.

It is pointed out that in the embodiments previously described (devices 10, 20, 30, 35) the coefficient of effective electro-optic coupling in the second guide 2 (k_{e0,2-eff}=0) has been made nil with various technical solutions. Instead, according to the embodiment in FIG. 10, relation (12) is satisfied with an effective coefficient k_{e0,2-eff} not equal to zero.

For example, to comply with relation (12) in this seventh embodiment, the first waveguide 1 and the second waveguide 2 are such as to exhibit birefringence satisfying the relation:
Δβ_{eo,1}<<Δβ_{eo,2} (13)

or, equivalently,
n_{TE1}−n_{TM1}>>n_{TE2-n}_{TM2} (14)

and in particular,
n_{TE1}≈n_{TM1} (15)

The relation (15) states that the first waveguide 1 advantageously has low birefringence, for example not more than 5.0·10⁻², preferably not more than 5.0·10⁻³, and therefore with a low value for the quantity Δβ_{eo,1}.

Instead, it is appropriate for the birefringence in the second waveguide 2 to be higher, for example at least equal to five times that of the first waveguide 1.

Moreover, to comply with relation (i), k_{coup,TE}≧k_{coup,TM}, that is to ensure that the coupling between the first guide 1 and the second guide 2 relating to the TE mode is no smaller than that relating to the TM mode, the refractive indices of the two guides may be adjusted by selecting n_{TE1} as approximately equal to n_{TE2}:
n_{TE1}≈n_{TE2} (16)

In fact, by applying relation (16) and relations (15) and (14), the refractive index of the first guide 1 for the TM mode, n_{TM1}, is made to be very different from that n_{TM2} of the second guide 2. In particular, the following is obtained:
n_{TM1}>>n_{TM2} (17)

and this implies compliance with condition (i), k_{coup,TE}≧k_{coup,TM}.

FIG. 11 shows an embodiment of the invention similar to that in FIG. 10, supplying more details of production.

The opto-electronic device 45 in FIG. 11 comprises the lower cladding 7, of silicon dioxide SiO2, on which is arranged, advantageously, an intermediate or buffer layer 46 produced, for example, from magnesium oxide (MgO) on which is grown the guiding layer 3 and, therefore, the two ridges 4 and 5. The guiding layer 3 and the ridges 4 and 5 are of barium titanate which exhibits an optical axis with the orientation <001>.

With the aim of reducing the birefringence of the first waveguide 1 in accordance with relation (15), on the respective ridge 4 is formed an additional layer 47, for example, of silicon nitride, Si3N4, or of other material having a refractive index greater than that of the upper cladding 8.

The electrodes 12 and 13 are produced, preferably from gold (Au) and are such as to generate the controlling electric field E̅_{cr} perpendicular to the optical axis c, and to the axis of propagation z.

Considering a wavelength of the incident optical radiation equal to λ=1.55 μm, the ordinary refractive index n_{ord} and the extraordinary one nₑₓₜ of barium titanate (BaTiO3) are equal to n_{ord}=2.1810 and nₑₓₜ=2.166.

The refractive index n_{SiO2} of the upper cladding 8 and lower cladding 7 is equal to 1.444, and the index n_{MgO} of the buffer 6 is 1.732, while the index of the additional layer 47 is equal to 2.2.

The barium titanate has an off-diagonal electro-optic coefficient r₄₂ equal to 500 pm/V.

The integrated device in FIG. 11 has the following dimensions:
thickness d1 of the lower cladding 7, d1>1.5 μm and, for example, less than 100 μm;
thickness d2 of the buffer 46, approximately equal to 100 nm;
thickness d3 of the guiding layer 3, approximately equal to 250 nm;
thickness d4 of the ridges 4 and 5 of the first waveguide 1 and the second 2, approximately equal to 550 nm; the thickness of the additional layer 47 is approximately equal to 200 nm;
width w1 of the ridge 4 of the first waveguide 1 is approximately equal to 700 nm;
width w2 of the ridge 5 of the second waveguide is approximately equal to 775 nm;
distance d between the two waveguides, approximately equal to 900 nm;
height h of the electrodes 12 and 13 greater than 1 μm and, for example, less than 1 mm;
distance d6 between the electrodes greater than 8 μm, and for example less than 50 μm.

The dimensioning of the device 45 indicated above leads to the following values of the refractive indices for the transverse electrical and transverse magnetic modes of the first guide 1 and of the second 2: n_{TE1}=1.9359, n_{TM1}=1.9354; n_{TE2}=1.9358, n_{TM2}=1.9083.

For the first guide 1 there is a birefringence of n_{TE1}−n_{TM1}=5·10⁻⁴, and for the second guide the birefringence is equal to n_{TE2}−n_{TM2}=0.0275. Moreover, k_{coup,TE}=0.0098 and k_{coup,TM}=0.0045.

The applicant has carried out a simulation on the basis of the dimensional values listed above. The results have shown that for a distance d6 between the electrodes equal to 10 μm, and with an applied voltage V_{cr} equal to about 1 V, an electric field E̅_{cr} is obtained inside waveguides 1 and 2 with an average value equal to about 0.05 V/μm. For this valuation, a dielectric constant of barium titanate for radiofrequency was considered, equal to about 1000.

The device 45 in FIG. 11 shows, in the absence of an electric field E̅_{cr}, a periodic curve of the TE mode of the second waveguide 2, with a period equal to 160 μm.

The active region 100 may have a length equal to z″=5930 μm, corresponding to about thirty-seven times the period indicated above.

FIG. 12 shows the curve, when the voltage applied to the electrodes 12 and 13 is varied, of the power Pₒᵤₜ₂ present at the output of the second waveguide 2 in the case of a length equal to the value z″ indicated above. This power Pₒᵤₜ₂ takes account both of the TE2 mode, and also of the TM2 mode which are propagated in the second waveguide 2.

The graph in FIG. 12 also shows that for voltage values comprised between about 9.5 V and 10.5 V, extinction of the power of over 20 dB is obtained.

In particular, for a value approximately equal to 10 V, extinction of about 35 dB is obtained.

FIG. 12 also shows that for a control voltage V_{cr} with a value of about 9.5 V extinction is reduced to 15 dB.

For the purposes of operating as an amplitude modulator or as a switch, the control voltage V_{cr} of the device 45 in FIG. 11 may be varied within a particular range of values. For example, in accordance with the results of the experiments in FIG. 12, the voltage V_{cr} may vary between 9.5V and 10.5 V.

It is possible to apply this control voltage V_{cr} by separating it into a constant bias voltage V_{bias} (for example, of about 7 V) to which there corresponds a constant controlling electric field, and a variable voltage Vᵥₐᵣ (for example, having a peak-to-peak voltage of 5 V).

The constant voltage V_{bias} enables the operating point to be fixed at a specific value of the power present at the output OUT2, for example equal to 50% of the power at the input OUT1. The variable voltage Vᵥₐᵣ gives rise to a variable electric field which enables the power at the output OUT2 to be modulated.

FIG. 13 shows on a linear scale the curve of the output power Pₒᵤₜ₂ at the second output 2, and also the values V_{bias}=7 V and Vᵥₐᵣ=5 V obtained following the simulation carried out for the device 45.

It should be noted that it is advantageous for the constant electric field, corresponding to the bias voltage V_{bias} and the variable voltage, corresponding to the variable voltage Vᵥₐᵣ, to act upon the entire active region 100 of the device 45.

In this connection, FIG. 14 shows a device 55 similar to the device 45 in FIG. 11, but comprising a structure of electrodes particularly suitable for securing substantially uniform distribution over the whole active region 100 of the bias electric field and the variable field.

In more detail, the opto-electronic device 55 includes a bias electrode B_{elect} arranged above the upper cladding 8 and facing towards the region of the guiding layer 3 which extends between the first waveguide 1 and the second 2.

The bias electrode B_{elect} is produced, for example, of polysilicon doped so as to constitute an electrical insulator (that is a dielectric) at high frequency and an electrical conductor in static or low frequency conditions.

The opto-electronic device 55 is provided with a constant voltage generator DC-G having a first terminal connected to the bias electrode B_{elect} and a second terminal connected to the negative electrode 13. A variable voltage generator RF-G (for example, operating at radiofrequency RF) is connected to the negative electrode 13 and positive electrode 12.

The bias electrode B_{elect}, behaving at high frequency as an insulator, is unaffected by the radiofrequency voltage generated by the variable voltage generator RF-G and supplied to the negative electrode 13.

In operation, a constant electrical potential (for example 7V) may be applied to the bias electrode B_{elect}. Between the positive electrode 12 and negative electrode 30, the oscillating voltage Vᵥₐᵣ (for example, variable within a range of ±2.5 V) is applied. Thus the bias electrode B_{elect} sees the positive electrode 12 at a voltage equal to the average value Vₘ of the variable voltage Vᵥₐᵣ applied to it (for example Vₘ is 0V). Therefore, the positive electrode 12 is on average at a lower potential (typically nil) compared with that of the bias electrode V_{bias}.

This implies that the lines of force of the electrical bias field E̅_{bias} and those of the variable electric field E̅ᵥₐᵣ are directed as shown schematically by continuous lines in FIG. 14.

In particular, in the first waveguide 1 and in the second 2, the two electric fields are orthogonal to the optical axis c and to the propagation axis z.

Alternatively, to apply the bias electric field E̅_{bias} and the variable field E̅ᵥₐᵣ in the appropriate manner, a conventional bias tee device known in the sector may be used.

It is pointed out that even though the description given above referred to input radiation corresponding to the TE mode, the disclosures of the invention are also applicable to the case where linearly polarised radiation of the TM type is introduced into the first waveguide 1.

In the case where TM radiation is injected, the radiofrequency electric field will be directed along the same direction described with reference to the previous embodiments of the invention and the directional coupler 11 will be configured so that k_{coup,TM}≧k_{coup,TE}.

It is pointed out that the devices produced in accordance with the invention are such that they can operate not only as modulators but also as open-or-closed switches, changeover switches or attenuators.

In this connection, referring to FIG. 2, in the absence of a controlling electric field, the radiation introduced at the first input IN1 is coupled to the second waveguide 2 and is made available at the second output OUT2 (crossover state of the switch). Where the controlling electric field E̅_{cr} is present, it is possible to reduce or substantially cancel the radiation present at the second output 2 by bringing the opto-electronic device 10 into the straight-through or bar state. In this case, the power introduced at the first input IN1 is made available (at least in part) at the first output OUT1.

The opto-electronic device according to the invention offers the functionalities of an optical switch or of an optical modulator with satisfactory performance. The simulations carried out have shown that it is possible to obtain extinction values for the output power suitable for use in optical communications systems by applying a control voltage V_{contr} of suitable amplitude for applications of this type.

Moreover, as already shown, the solution disclosed by the invention also has the advantage of allowing switching/modulation of the output power which is not critically dependent on the birefringence of the waveguides used and which, therefore, is less sensitive to manufacturing inaccuracies in the device.

1-35. (canceled)

36. An opto-electronic device comprising:
a directional coupler comprising:
a first waveguide provided with an input to receive incoming electromagnetic radiation, said first guide comprising a guiding region of electro-optic material, and
a second waveguide into which can be coupled at least a first portion of said incoming radiation, said second guide being provided with an output for outgoing radiation; and
a structure to generate a controlling electric field at least inside said first guide such as to cause in the electro-optic material polarization conversion of at least part of the incoming radiation, said polarization conversion being such as to modify the first portion of the radiation coupled to the second guide.

37. The device according to claim 36, wherein said polarization conversion is of such magnitude as to allow control of the power associated with the radiation being output from the second waveguide.

38. The device according to claim 37, wherein said polarization conversion enables the power associated with the radiation being output from the second waveguide to be reduced.

39. The device according to claim 36, wherein the structure for generating the controlling electric field is such that said at least part of the incoming radiation converted has a power with a value greater than 1% of the power associated with the incoming radiation.

40. The device according to claim 39, wherein the structure for generating the controlling electric field is such that said value is greater than 5% of the power associated with the incoming radiation.

41. The device according to claim 36, wherein the first waveguide, the second waveguide and the structure for generating the controlling electric field are such that, in predefined operating conditions, the polarization conversion effect in the first waveguide is greater than polarization conversion obtainable inside the second waveguide by means of an electro-optic effect caused by the structure for generating the controlling electric field.

42. The device according to claim 41, wherein, in said predefined operating conditions, there is associated with the first optical waveguide a first coefficient of electro-optic coupling representing the effect of said polarization conversion in the first waveguide, and with the second waveguide there can be associated a second coefficient of electro-optic coupling representing the effect of polarization conversion in the second waveguide, the first coefficient being greater than the second coefficient.

43. The device according to claim 41, wherein said incoming radiation has a first type of polarization and said structure is capable of converting at least part of the incoming radiation into a second type of polarization, the directional coupler having associated with it a third coefficient of coupling between said first and said second guide relating to the first type of polarization and having a value not less than a fourth coupling coefficient associated with the directional coupler and representing a coupling between said first and said second guide relating to the second type of polarization.

44. The device according to claim 41, wherein the directional coupler and the structure for generating the controlling electric field are such that the polarization conversion effect in the first waveguide is greater than the effect of coupling of at least a first portion of the incoming radiation from the first waveguide to the second waveguide.

45. The device according to claim 42, wherein the first coefficient of coupling is at least equal to twice the third coefficient of coupling.

46. The device according to claim 41, wherein the directional coupler and the structure for generating the controlling electric field are such that the effect of coupling of at least a first portion of the incoming radiation from the first waveguide to the second waveguide is greater compared with the polarization conversion effect in the first waveguide.

47. The device according to claim 43, wherein said fourth coefficient of coupling is substantially nil.

48. The device according to claim 41, wherein the first waveguide is such as to have associated with it a first birefringence less than a second birefringence associated with the second waveguide.

49. The device according to claim 48, wherein the first birefringence is no greater than a value equal to 5.0·10⁻².

50. The device according to claim 49, wherein the first birefringence is substantially nil.

51. The device according to claim 48, wherein the second birefringence is at least equal to five times the first birefringence.

52. The device according to claim 43, wherein the first waveguide is associated with a first refractive index relating to the first type of polarization substantially equal to a second refractive index associated with the second waveguide and relating to the first type of polarization.

53. The device according to claim 41, wherein said polarization conversion effect inside the second waveguide enables further converted radiation to be generated, having a power with a value of less than 1% of the power of said at least one portion of the incoming radiation coupled from the first waveguide to the second waveguide.

54. The device according to claim 41, wherein the second waveguide includes electro-optic material and said structure for generating the controlling electric field is such as to cause polarization conversion substantially only inside the first waveguide.

55. The device according to claim 53, wherein the second waveguide is produced with substantially non-electro-optic material.

56. The device according to claim 36, wherein said first and second guide comprise, respectively, a first section and a second section arranged one beside the other to allow coupling of the first portion of incoming radiation, said structure being such as to generate the controlling electric field at least inside said first section.

57. The device according to claim 56, wherein said structure for generating the controlling electric field comprises a first electrode and a second electrode which can be fed by means of an electrical voltage generator to generate the controlling electric field at least inside said first section of the first waveguide alongside said second section of the second waveguide.

58. The device according to claim 36, wherein the first and the second waveguide comprise, respectively, a respective guiding layer integrated on a respective lower cladding, the guiding layer having a first refractive index greater than a second refractive index of the lower cladding to allow propagation of electromagnetic radiation substantially inside the guiding layer.

59. The device according to claim 58, wherein said first and second waveguide also comprise a respective upper cladding arranged above said guiding layer and having a third refractive index smaller than the first refractive index to allow propagation of electromagnetic radiation substantially inside the guiding layer.

60. The device according to claim 58, wherein at least the guiding layer of the first waveguide includes the electro-optic material of crystalline type and having an optical axis associated with it.

61. The device according to claim 60, wherein said structure for generating the electric field is such as to generate an electric field oriented, at least inside the guiding layer of the first waveguide, perpendicularly to the optical axis.

62. The device according to claim 43, wherein said first and second type of polarization are linear.

63. The device according to claim 61, wherein said controlling electric field is oriented in a manner substantially perpendicular to a direction of propagation of the first waveguide.

64. The device according to claim 36, wherein said controlling electric field is such as to cause an electro-optic effect which involves an off-diagonal electro-optic coefficient of an electro-optic tensor associated with said material.

65. The device according to claim 36, wherein said electro-optic material is barium titanate.

66. A method for controlling the power associated with electromagnetic radiation, the method comprising the steps of:
sending incoming radiation into a first waveguide, provided with at least one section including electro-optic material;
coupling into a second waveguide at least a first portion of the incoming radiation, generating in said second guide outgoing radiation having associated with it a respective power, the second waveguide being side by side with the first waveguide for a coupling section; and
inducing an electro-optic effect in the first waveguide to cause polarization conversion of at least part of the incoming radiation so as to modify the first portion of radiation coupled to the second waveguide and control the power of the radiation being output.

67. The method according to claim 66, wherein said induction step comprises a step of generating a controlling electric field having lines of force which extend at least inside the electro-optic material of the first waveguide.

68. The method according to claim 67, wherein the generation step comprises generating a controlling electric field variable in time according to a predetermined modulation frequency so as to modulate the power of the output radiation.

69. The method according to claim 67, wherein the generating step comprises a step of switching the controlling electric field between a first value and a second value, said first value having corresponding to it a first power of the output radiation and said second value having corresponding to it a second power of the output radiation less than the first power.

70. The method according to claim 69, wherein said second value has corresponding to it substantially nil power of the radiation being output.
